(19) United States
(12) Patent Application Publication
(10) Pub. No.: US 2023/0019757 A1
(43) Pub. Date: Jan. 19, 2023

(54) ANTI-FOG MASK

(71) Applicant: Clayton Turnbow, Las Vegas, NV (US)

(72) Inventor: Clayton Turnbow, Las Vegas, NV (US)

(21) Appl. No.: 17/379,850

(22) Filed: Jul. 19, 2021

(51) Int. Cl. A62B 18/08; A41D 13/11

(52) U.S. Cl. CPC A62B 18/08; A41D 13/1107; A62B 18/084

(57) ABSTRACT

An illustrated view of an exemplary improved mask for preventing eye-glasses from fogging up is presented. The mask is useful for preventing air to flow from the mask onto the eyeglasses of the wearer of the mask. Also, the mask is useful preventing the spread of infectious diseases such as COVID. The mask provides for limited touching of the mask. The mask further is light-weight, comfortable and cost efficient.

### FIELD OF THE INVENTION

This invention relates to masks. More particularly, it relates to reducing and/or eliminating fog on glasses from wearing a mask.

### BACKGROUND

The ongoing COVID-19 pandemic was confirmed to have reached the United States in January 2020. The first confirmed case of local transmission was recorded in January, while the first known deaths happened in February. By the end of March, cases had occurred in all 50 U.S. states, the District of Columbia, and all inhabited U.S. territories except American Samoa. As of Jun. 24, 2020, the U.S. had the most confirmed active cases and deaths in the world. As of Jul. 16, 2020, its death rate was 419 per million people, the seventh-highest rate globally.

The Center for Disease Control (CDC) has issued a recommendation to the US population for prevention of contracting COVID 19 as well as other infectious diseases. Those recommendations are: 1) wash hands often; 2) avoid close contact (social distancing); 3) cover mouth and nose with a cloth face cover when around others; 4) cover cough or sneezes; 5) clean and disinfect; and 6) monitor your health daily.

A protective mask, an item of personal protective equipment (PPE), aims to protect the wearer from potentially infectious materials by covering the nose and mouth of the person from airborne viruses. With the recent CDC guidelines for the COVID-19 pandemic, many have turned to masks that cover at least a part of their face, in particular their nose and mouth. Protective masks are pieces of kit or equipment worn on the head and face to afford protection to the wearer, and today usually have these functions: providing a supply of air or filtering the outside air (respirators and dust masks).

Although protective masks are important and should (must) be worn to protect not only the person wearing the protective mask but also those around them.

One of the major issues around the wearing of a mask is that when a person is wearing a mask and glasses, their glasses can fog up and visual impact for the communication is often difficult for the receiving party to understand. Similarly, it is common that a mask muffles the sound of the voice or can make it inaudible. When a person needs to speak, they remove their masks. This is a problem as removing of the masks in and/or around others falls outside of the recommendations of the CDC and can promote spreading of infectious diseases such as COVID.

Accordingly, and in light of the foregoing, it would be desirable to devise an improved mask that prevents air and breath within the mask from fogging glasses being worn by the mask wearer. It would be further advantageous if the improved mask were more comfortable, cost effective, water proof and light-weight.

### BRIEF DESCRIPTION OF THE DRAWINGS

FIG. 1 is an illustrated view of an exemplary improved mask.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

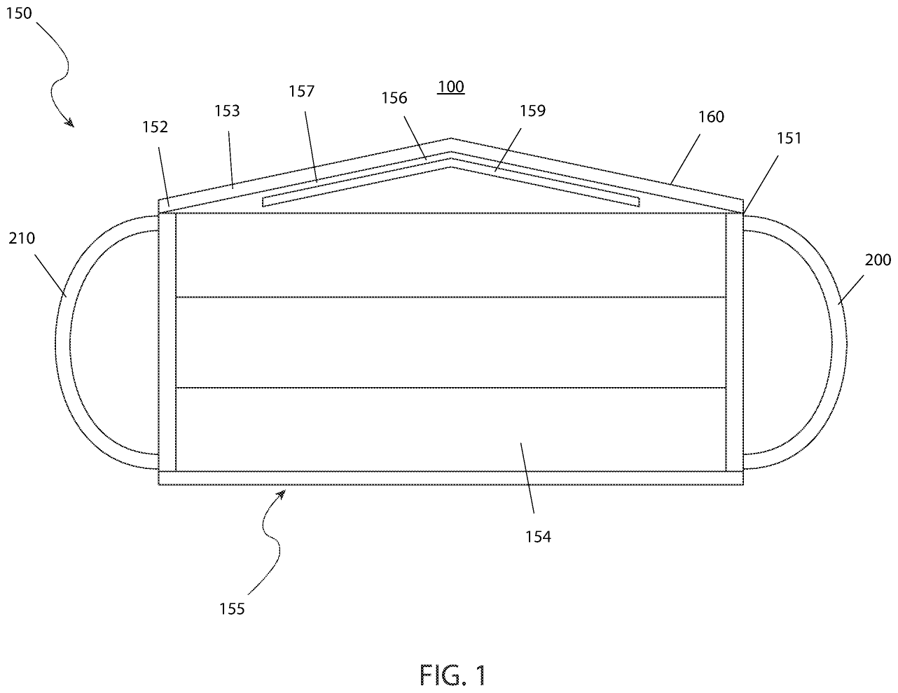

Referring to FIG. 1, an illustrated view of an exemplary improved mask 100 for preventing eye-glasses from fogging up is presented. The mask 100 is useful for preventing air to flow from the mask 100 onto the eyeglasses of the wearer of the mask 100. Also, the mask 100 is useful preventing the spread of infectious diseases such as COVID-19. The mask 100 provides for limited touching of the mask 100. The mask 100 further is light-weight, comfortable and cost efficient.

The mask 100 has a panel 150, and a plurality of first coupling devices 200, 210. The panel 150 of the mask 100 is preferably ten (10) inches in width, however other widths are hereby contemplated, including, but not limited to, eight (8) inches, eleven (11) inches, etc. The panel 150 of the mask 100 is preferably five (5) inches in height, however other heights are hereby contemplated, including, but not limited to, three (3) inches, seven (7) inches, etc. The panel 150 of the mask 100 is preferably made of a quilted cotton material, however other materials are hereby contemplated, including, but not limited to, paper, denim, etc. The plurality of first coupling device 200, 210 are preferably made of an elastic material, however other materials are hereby contemplated, including, but not limited to, cotton, polyester blend, nylon, rubber, etc.

The panel 150 has a first end 151, a second end 152, a top 153, a bottom 154, a front 155 and a back 160.

A first of the first coupling devices 200 is coupled to the first end 151 of the panel 150 preferably by a stitching. A second of the first coupling devices 210 is coupled to the second end 152 of the panel 150 preferably by a stitching. The first of the first coupling devices 200 is coupled to a first ear of a person to secure the mask 100 onto a face of the person. The second of the first coupling devices 210 is coupled to a second ear of the person to further secure the mask 100 to the face of the person.

The back 160 of the panel 150 has a second coupling device 156. The second coupling device 156 which is configured near the top 153 of the back 160 of the panel 150. The second coupling device 156 is useful for securely coupling the mask 100 to a bridge of a nose of the person, such that the air with water vapors do not escape from the mask 100 to fog eye-glasses (not shown) of the person. The second coupling device 156 is preferably an adhesive strip 157 protected by a cover 158. The cover 158 is removably coupled to a top 159 of the adhesive strip 157. The person picks up the mask 100 by the front 155 of the panel 150 of the mask 100. The person then removes the cover 158 from a top 159 of the adhesive strip 157. The person then couples the first coupling devices 200, 210 to the ears of the person (not shown). Then the person presses the front 155 of the panel 150 of the mask 100 significantly near the top 153 of the front 155 of the panel 150 of the mask 100, such that the adhesive strip 157 of the back 160 of the panel 150 of the mask 100 is securely coupled to the bridge of the nose of the person (not shown).

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. An improved mask for allowing clearer voice communication, the mask comprising:
a panel, the panel comprising:
a first end;
a second end;
a top;
a bottom;
a front;
a back, the back having a second coupling device, the second coupling device being coupled to a top of the back of the panel; and
a plurality of first coupling devices, a first of the first coupling devices being coupled to the first end of the panel, and a second of the first coupling devices being coupled to the second end of the panel.

2. The mask of claim 1, wherein the panel has a width of ten (10) inches.

3. The mask of claim 1, wherein the panel has a height of five (5) inches.

4. The mask of claim 1, wherein each of the plurality of first coupling devices is made of an elastic material.

5. The mask of claim 1, wherein the second coupling device is a hook and loop fastener.

6. The mask of claim 1, wherein the second coupling device is an adhesive strip.

7. The mask of claim 6, wherein the adhesive strip has a cover, the cover being removably coupled to a top of the adhesive strip.

8. The mask of claim 1, wherein panel is made of a quilted cotton material.
